(19) United States
(12) Patent Application Publication
(10) Pub. No.: US 2016/0343271 A1
(43) Pub. Date: Nov. 24, 2016

(54) EDUCATIONAL GAME SYSTEM

(71) Applicant: Elisah Carter, Chicago, IL (US)

(72) Inventor: Elisah Carter, Chicago, IL (US)

(21) Appl. No.: 15/162,252

(22) Filed: May 23, 2016

Related U.S. Application Data
(60) Provisional application No. 62/165,606, filed on May 22, 2015.

(51) Int. Cl. G09B 19/02

(52) U.S. Cl. CPC G09B 19/02

(57) ABSTRACT

An educational game system is provided having a plurality of counting pieces with a number mounted on each of the counting pieces. A resilient ball and a pair of dice are also provided. Upon tossing the ball upward, collecting at least a portion of the counting pieces, and catching the ball after one bounce of the ball, the numbers of the collected counting pieces are added creating a first total sum. Upon tossing the ball again upward, collecting at least a portion of the counting pieces, and catching the ball after one bounce of the ball, the numbers of the collected counting pieces are added creating a second total sum. Upon rolling the dice, the dice are added creating a dice total amount. Depending on the dice total amount, the first total sum is either added to, subtracted from, multiplied with, or divided by the second total sum.

### CLAIM OF PRIORITY

This patent application claims priority under 35 USC 119 (e) (1) from U.S. Provisional Patent Application Ser. No. 62/165,606 filed May 22, 2015, of common inventorship herewith entitled, “Nu Jacks,” which is incorporated herein by reference as though the same were set forth in its entirety.

### FIELD OF THE INVENTION

The present invention pertains to the field of entertainment, and more specifically to the field of educational games.

### BACKGROUND OF THE INVENTION

Many traditional games have proved themselves as valuable resources for teaching mathematical skills. They transform math education into a socially engaging, physical and sensory activity. This fun, alternate approach to teaching math makes learning and recalling mathematical concepts easier by giving abstract concepts a clear context. The game of jacks, one of the oldest games in human history, stresses counting and patterning to help a player develop basic math skills. Nearly every culture has its own version of jacks, but the basic principles of the game remain remarkably similar. In a traditional game, players take turns tossing or bouncing a ball or stone into the air and during the time it remains aloft, they must swiftly pick up combinations of pieces known as jacks and catch the ball as it comes back down.

The prior art has put forth several designs for educational games. Among these are:

U.S. Pat. No. 6,318,725 to Emmanuel Saint-Victor describes a challenging and patience developer game for two or more players. This invention relates to four six sided Jacks and a ball, specifically to a kind of Jacks marked with a word, letter, number, and suit attribute. After being thrown, the markings on the upper surfaces of the Jacks instruct the player to move forward in a pinnacle path of the game or perform a described activity. The game begins by holding all four trapezoidal Jacks in one hand. Turn hand over and gently drop Jacks onto playing surface. The object of the game is to toss drop the ball, pick up the Jacks, then catch the ball with the same hand. Let the ball hit the surface only once. Begin game by picking up only one Jack, then two, then three, then four. The rule of the game is to do the repetition of this numerically increasing activity for side A, then side B, then side C, then side D, with the purpose of working one's way to the pinnacle of the competition. With drops of the Jacks, the markings randomly show an instruction such as Skip One or Two Stages, Go Back One or Two Stages, Make Fun of Yourself or Announce: You Win It All. These instructions add tremendous fun and challenges to the game.

U.S. Pat. No. 5,957,452 to David L. Patton describes dice like, polyhedral solids to randomly generate lines of I Ching hexagrams. It produces outcomes according to a traditional and theoretically important frequency distribution. That distribution requires that the four line types of the I Ching system occur in a relative frequency of one:three:five:seven. The invention accomplishes this relative occurrence through a specific arrangement of indicia on the dice. The dice are so constructed and the indicia so disposed that any roll shall yield one of the numerical results six, seven, eight or nine. These values correlate with the four line types, and the statistical likelihood of each possible result conforms to the theoretically ideal frequency distribution of all such results. Three dice are used in the preferred embodiment, each of a rounded and substantially tetrahedral form.

U.S. Patent D519,588 to Kurt K. Carbonero describes an ornamental design of a jack toy.

None of these prior art references describe the present invention.

### SUMMARY OF THE INVENTION

It is an object of the present invention to provide an entertaining game that develops and promotes an individual's mathematical, problem solving, fine motor, and memory and recall skills.

The present invention is an educational game system comprising a plurality of counting pieces with a number label mounted on each of the counting pieces. Each number label has a number. A resilient ball and a pair of dice are also provided. Upon tossing the ball in a generally upward direction, collecting at least a portion of the counting pieces, and catching the ball after one bounce of the ball on a surface, the numbers on the number labels of the collected counting pieces are totaled creating a first total sum. Upon tossing the ball again in a generally upward direction, collecting at least a portion of the counting pieces, and catching the ball after one bounce of the ball on a surface, the numbers on the number labels of the collected counting pieces are totaled creating a second total sum. Upon rolling the dice, the dice are totaled creating a dice total amount. Depending on the dice total amount, the first total sum is either added to, subtracted from, multiplied with, or divided by the second total sum.

In addition, the present invention includes a method for playing a game. The method comprises providing a plurality of counting pieces, mounting a number label on each of the counting pieces with each number label being a number, providing a resilient ball, providing a pair of dice, tossing the ball in a generally upward direction, collecting at least a portion of the counting pieces, catching the ball after one bounce of the ball on a surface, totaling the numbers on the number labels of the collected counting pieces creating a first total sum, tossing the ball again in a generally upward direction, collecting at least a portion of the counting pieces, catching the ball after one bounce of the ball on a surface, totaling the numbers on the number labels of the collected counting pieces creating a second total sum, rolling the dice, totaling the dice creating a dice total amount, and adding the first total sum to the second total sum, subtracting the second total sum from the first total sum, multiplying the first total sum with the second total sum, or dividing the first total sum by the second total sum depending on the dice total amount.

The present invention further includes an educational game system comprising a plurality of counting pieces and a number label mounted or embossed on each of the counting pieces. Each number label is selected from one of seven numbers. A resilient ball and a pair of dice are also provided. Upon tossing the ball in a generally upward direction, collecting at least a portion of the counting pieces, and catching the ball after one bounce of the ball on a surface, the numbers on the number labels of the collected counting pieces are totaled creating a first total sum. Upon tossing the ball again in a generally upward direction, collecting at least a portion of the counting pieces, and catching the ball after one bounce of the ball on a surface, the numbers on the number labels of the collected counting pieces are totaled creating a second total sum. Upon rolling the dice, the dice are totaled creating a dice total amount. When the dice total amount is (a) one to three, the player adds the second total sum to the first total sum, (b) four to six, the player subtracts the second total amount from the first total amount, (c) seven to nine, the player multiplies the first total amount by the second total amount, and (d) ten to twelve, the player divides the first total amount by the second total amount.

### BRIEF DESCRIPTION OF THE DRAWINGS

FIG. 1 is a perspective view illustrating an educational game system, constructed in accordance with the present invention, with numbered jack pieces which are components of the present invention.

FIG. 2 is a perspective view illustrating scoring cards of the educational game system, constructed in accordance with the present invention.

FIG. 3 is a perspective view illustrating the educational game system, constructed in accordance with the present invention, with numbered jack pieces, a pair of dice, and a rubber ball.

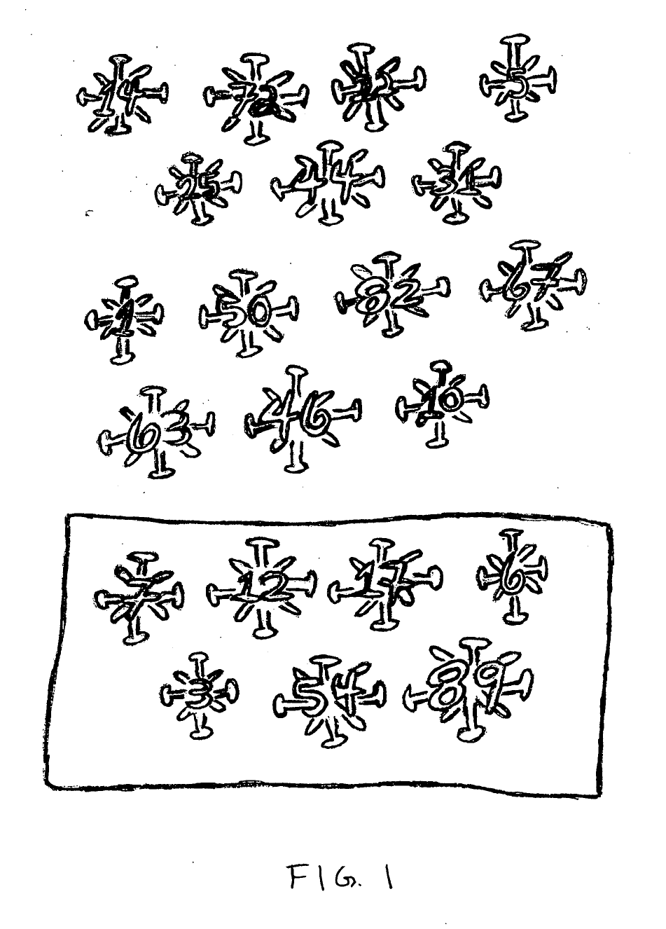

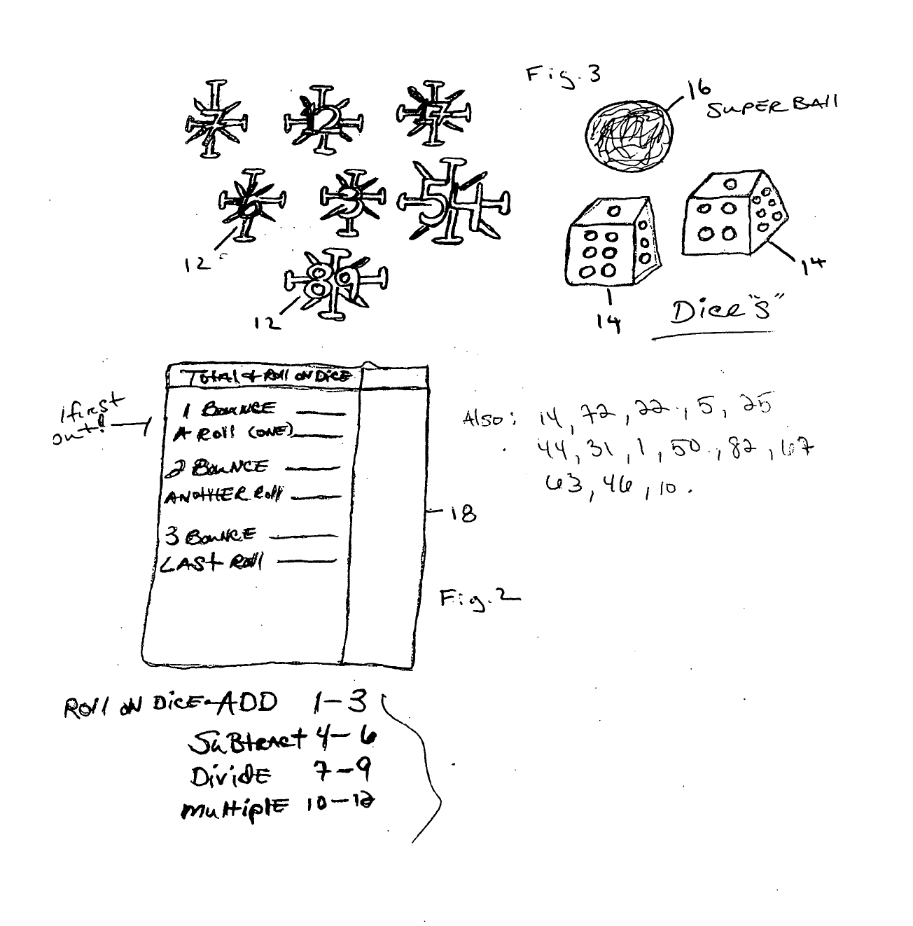

### DETAILED DESCRIPTION OF THE INVENTION

The present invention, hereinafter referred to as an Educational Game System, indicated generally at 10, is an educational game played with a plurality of counting pieces 12, a pair of dice 14, a ball 16, and a scorecard 18. Similar to a game of jacks, players bounce the ball 16 and pick up at least a portion of the counting pieces 12 that they then add, subtract, multiply or divide according to the player's dice roll. The Educational Game System 10 is constructed to create a game that is fun to play and also reinforces fundamental math skills. The Educational Game System 10 takes the basic game of jacks and pushes it one step further, increasing both the challenge of the game and its performance as an educational tool.

The counting pieces 12 used in playing the Educational Game System 10 of the present invention are preferably constructed like traditional jacks, with each counting piece 12 consisting of six points 20, or knobs, proceeding from a common base 22, and are preferably constructed from a metal or plastic material. Each counting piece 12 further includes an additional number label 24 visibly mounted on the points 20 and/or common base 22 of each counting piece 12. In a preferred embodiment, the Educational Game System 10 includes approximately twenty-one counting pieces 12 containing a number label 24 with one of the designated numbers of three, six, seven, twelve, seventeen, fifty-four, and eighty-nine. It should be noted that while the number label 24 can include the designated number listed above, it is within the scope of the present invention for the number label 24 to include different number than those set forth above.

In addition, the Educational Game System 10 of the present invention includes the small rubber ball 16 and the pair of six sided dice 14, making the Educational Game System 10 an approximately twenty-four piece game system. Further, the book of score sheets 18 is included for players to perform and record their calculations throughout the game.

The rules for the Educational Game System 10 of the present invention are easy and straightforward. The game is turn-based with each player's action following play action of a preceding player. The game requires a flat playing surface such as a desk, table, or floor. To begin play, a beginning player randomly shakes up the counting pieces 12 and drops the counting pieces 12 on the playing surface. The same player bounces the rubber ball 16. While the ball 16 is in the air, the player picks up as many of the counting pieces 12 as possible before catching the ball 16. The player calculates the sum of all numbers 24 mounted on the counting pieces 12 and records a total on their score sheet. The remaining players sequentially play their initial turns as described above.

On each player's second turn at play of the Educational Game System 10 of the present invention, the player performs the same sequence of actions of tossing the ball 16, collecting counting pieces 12, and catching the ball 16 in air. After counting and totaling numbers on the collected counting pieces 12, the player rolls the pair of dice 14 to determine whether he adds, subtracts, multiplies, or divides the newly collected number total to his existing number total. For example, on a roll of one to three, the player adds the new total to the existing total. On a roll of four to six, the player subtracts the new total from the existing total. On a roll of seven to nine, the player multiplies the existing total by the new total. On a roll of ten to twelve, the player divides the existing total by the new total. The play pattern is repeated for a total of three rounds or until the players decide the game is over.

Most educators and cognitive scientists agree that the ability to recall basic math facts fluently is necessary for students to attain higher order math skills. The mental and physical aspects of the game of the Educational Game System 10 of the present invention combine mental calculations with social interaction as well as stimulate a minimal but engaging amount of manual dexterity and motor coordination. In this manner, the Educational Game System 10 promotes development and maintenance of an individual's social interaction, problem solving skills, and fine motor skills and reflexes. Functional for children and adults, the game of the Educational Game System 10 is durably constructed and provides hours of entertainment while sharpening dexterity, building and tuning fine motor skills, and honing memory and recall.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. An educational game system comprising:
a plurality of counting pieces;
a number label mounting on each of the counting pieces;
a resilient ball; and
a pair of dice;
wherein upon tossing the ball in a generally upward direction, collecting at least a portion of the counting pieces, and catching the ball after one bounce of the ball on a surface, the numbers on the number labels of the collected counting pieces are totaled creating a first total sum;
wherein upon tossing the ball again in a generally upward direction, collecting at least a portion of the counting pieces, and catching the ball after one bounce of the ball on a surface, the numbers on the number labels of the collected counting pieces are totaled creating a second total sum;
wherein upon rolling the dice, the dice are totaled creating a dice total amount; and
wherein depending on the dice total amount, the first total sum is either added to, subtracted from, multiplied with, or divided by the second total sum.

2. The educational game system of claim 1 wherein each counting piece consists of six points proceeding from a common base.

3. The educational game system of claim 1 wherein the number label is mounted on the points and/or common base of each counting piece.

4. The educational game system of claim 1 wherein each number label is a number chosen from seven numbers.

5. The educational game system of claim 4 and further comprising:
twenty-one counting pieces with each counting piece having a number label containing one of the designated numbers of three, six, seven, twelve, seventeen, fifty-four, and eighty-nine.

6. The educational game system of claim 1 and further comprising:
a book of score sheets.

7. The educational game system of claim 6 wherein the first total sum and the second total sum are recorded on one of the score sheets.

8. The educational game system of claim 1 wherein the dice total amount is (a) one to three, the player adds the second total sum to the first total sum, (b) four to six, the player subtracts the second total amount from the first total amount, (c) seven to nine, the player multiplies the first total amount by the second total amount, and (d) ten to twelve, the player divides the first total amount by the second total amount.

9. A method for playing a game, the method comprising:
providing a plurality of counting pieces;
mounting a number label on each of the counting pieces, each number label being a number;
providing a resilient ball;
providing a pair of dice;
tossing the ball in a generally upward direction;
collecting at least a portion of the counting pieces;
catching the ball after one bounce of the ball on a surface;
totaling the numbers on the number labels of the collected counting pieces creating a first total sum;
tossing the ball again in a generally upward direction;
collecting at least a portion of the counting pieces;
catching the ball after one bounce of the ball on a surface;
totaling the numbers on the number labels of the collected counting pieces creating a second total sum;
rolling the dice;
totaling the dice creating a dice total amount; and
adding the first total sum to the second total sum, subtracting the second total sum from the first total sum, multiplying the first total sum with the second total sum, or dividing the first total sum by the second total sum depending on the dice total amount.

10. The method of claim 9 wherein the dice total amount is (a) one to three, the player adds the second total sum to the first total sum, (b) four to six, the player subtracts the second total amount from the first total amount, (c) seven to nine, the player multiplies the first total amount by the second total amount, and (d) ten to twelve, the player divides the first total amount by the second total amount.

11. An educational game system comprising:
a plurality of counting pieces;
a number label mounting on each of the counting pieces, each number label being a number selected from one of seven numbers;
a resilient ball; and
a pair of dice;
wherein upon tossing the ball in a generally upward direction, collecting at least a portion of the counting pieces, and catching the ball after one bounce of the ball on a surface, the numbers on the number labels of the collected counting pieces are totaled creating a first total sum;
wherein upon tossing the ball again in a generally upward direction, collecting at least a portion of the counting pieces, and catching the ball after one bounce of the ball on a surface, the numbers on the number labels of the collected counting pieces are totaled creating a second total sum;
wherein upon rolling the dice, the dice are totaled creating a dice total amount; and
wherein the dice total amount is (a) one to three, the player adds the second total sum to the first total sum, (b) four to six, the player subtracts the second total amount from the first total amount, (c) seven to nine, the player multiplies the first total amount by the second total amount, and (d) ten to twelve, the player divides the first total amount by the second total amount.

12. The educational game system of claim 11 wherein each counting piece consists of six points proceeding from a common base.

13. The educational game system of claim 11 wherein the number label is mounted on the points and/or common base of each counting piece.

14. The educational game system of claim 11 and further comprising:
twenty-one counting pieces with each counting piece having a number label containing one of the designated numbers of three, six, seven, twelve, seventeen, fifty-four, and eighty-nine.

15. The educational game system of claim 11 and further comprising:
a book of score sheets.

16. The educational game system of claim 15 wherein the first total sum and the second total sum are recorded on one of the score sheets.
